(19) United States
(12) Patent Application Publication
(10) Pub. No.: US 2005/0216429 A1
(43) Pub. Date: Sep. 29, 2005

(54) System and method for collaborative systems engineering

(76) Inventors: Michael T. Hertz, Manassas, VA (US); Daniel J. Cernoch, Liverpool, NY (US)

Correspondence Address: NIXON PEABODY, LLP, 401 9TH STREET, NW, SUITE 900, WASHINGTON, DC, 20004-2128, US

(21) Appl. No.: 10/807,382

(22) Filed: Mar. 24, 2004

(51) Int. Cl. G06F 7/00

(52) U.S. Cl. 707/1

(57) ABSTRACT

A process converts stand-alone data sources to an open standard based architecture and integrates data throughout disparate departments and organizations. Once the data is in an open environment, it is made available in a collaborative environment via Web-based applications. The process does not require that the data come under the control of a central database, rather each data owner retains control. The invention allows users to maintain original processes for conducting their day-to-day activities. With minor modification to client applications, role-based interconnectivity of data can be established to allow data elements to be re-used by all downstream users without re-entering data, thereby improving product and process knowledge, preventing errors, handling data arbitration, improving data visibility and flexibility for decision makers, and saving resources thereby allowing collaborators to focus on core business competencies.

### FIELD OF THE INVENTION

The invention relates generally to collaborative systems engineering and operations support environments. More particularly, the invention relates to a collaborative environment that integrates disparate logistic and supply support tools to enable fusion of data across departments and organizations.

### BACKGROUND OF THE INVENTION

All companies must integrate new technologies with older processes and legacy tools to successfully evolve and compete in changing business environments. While implementing new processes, it is essential to continue to utilize existing and older systems to maintain asset visibility during the life of the product as well as to gather data to be used to compile historical information regarding the product with which to improve and update existing processes. Timely and accurate information with regard to the location, movement, status, and identity of assets and processes facilitates an organization's ability to act upon gathered data to improve overall business performance. Without an efficient manner of integrating data from older systems, extensive resources are required to gather, analyze, present, and implement historical and ongoing information. Human integration of this data is extremely difficult, burdensome, and prone to errors. When multiple systems are employed in multiple geographic locations, these problems quickly compound.

Conventional collaborative multi-disciplinary environments are used in the design, development, production, and support of complex systems. A collaborative multi-disciplinary environment links information from various multi-disciplinary groups involved with different aspects of a complex system to form a common information model that represents the complex system. A collaborative multi-disciplinary environment provides discipline-specific views of an information model and integrates the discrete tools and processes with a managed repository of information representing the complex system.

Conventional collaborative engineering and operations environments allow the allocation of tasks to those persons or organizations with the experience and resources to most efficiently perform those tasks. The best allocation of tasks results in the best application of resources. In a collaborative support environment, all data is available to all contributors in real time, and all contributors may observe the same data at any time. Constraints upon the data and upon the products are imposed automatically as contributors dictate changes. Modifications to the products and processes are tracked automatically and pass immediately into a digital electronic documentation history of the current product or process under scrutiny. This allows for proper tracking of design improvements, fault analysis, inventory management, and any process by which multiple contributors may make individual contributions with an eye toward the collective output.

Information management technologies and design tool capabilities provide the opportunity to facilitate collaborative engineering processes. These collaborative systems include system engineering and design organizations, as well as customer and industry program management, procurement, manufacturing, maintenance, user training, and operations management. Immediate access to the latest product information, as well as access to all associated historic information, tools, models, and simulations, enables greater reach and more rapid turnaround of design alternatives as well as more efficient management of inventory and ongoing operational processes. At the same time, product design engineers can achieve a higher level of confidence in their chosen designs since they may now consider a greater scope of pertinent design parameters and factors. Cost considerations and integration planning of deliberate obsolescence, inventory management, other manufacturing resource planning functions is available early and throughout the system life cycle and are more easily managed and complete in scope, enabling not only cost competitive system development, but optimized support of the released system.

A collaborative engineering and operations environment provides an inter-enterprise mechanism for design engineers, systems integrators, contractors, suppliers, partners, users, and customers to communicate. The environment provides an architecture linking multiple systems and applications to enable collaboration to conceive, develop, produce, sustain, improve, and ultimately retire complex system products. Critical information is made readily available to every member of the extended enterprise. In this fashion, collaborative multi-disciplinary environments may be implemented to manage and leverage various activities among the disciplines involved. Using a collaborative multi-disciplinary environment, the various disciplines contributing to decisions associated with the complex system can exploit synergies that result from the timely and reliable exchange of information.

However, current collaborative engineering and operations environments are deficient and require additional management to foster the necessary collaboration, as well as additional time and labor to coordinate and exchange information.

The lack of true interconnectivity between departments and organizations that utilize diverse computer systems is a basic barrier to collaborative engineering environments and the true ability to accurately and reliably exchange data. While standards currently exist to support the sharing of design information across different operating systems and network protocols, conversion of the data to a common format and digital representation often serves to bottleneck the collaboration. Known systems and methodologies in the area of collaboration engineering and operations support environments all fall short.

One of these deficient systems used to enable interaction in enterprise site planning is set forth in U.S. Pat. No. 5,931,900 (the '900 patent) issued to Notani et al. This system enables interaction between different domains by employing an inter-domain connectivity plane with a first domain engine associated with the first domain and a second domain engine associated with the second domain engine. The first and second domain engines perform domain analysis functions. Additionally, the system employs adapters associated with the first and second native sources. The adapters abstract data and information from the first and second native sources onto the inter-domain connectivity plane. However, the system in the '900 patent requires that the adapters be loaded to interface to particular sources of information. While the adapters may be stored and re-used, they must be accessed and run each time the particular source of information is accessed.

Another system providing access to documents of different formats is set forth in U.S. Pat. No. 6,064,977 (the '977 patent) and U.S. Pat. No. 6,301,621 (the '621 patent) both issued to Haverstock et al. These systems employ a web server, a Hyper Text Markup Language (HTML) translator, and databases in which a variety of objects of different types are stored. The HTML translator converts non-HTML objects to HTML format and sends the HTML downloaded object to a client side browser for display. However, the systems fail to integrate applications but rather retrieve non-HTML objects using a non-HTML server and translate the objects each time they are requested. This is repetitive and an inefficient use of computing resources.

Another deficient method and apparatus for collaboratively managing supply chains is set forth in U.S. Pat. No. 6,157,915 (the '915 patent) issued to Bhaskaran et al. This apparatus appears to permit collaboration through domain task-specific active documents. However, this apparatus does not provide a manner in which data is compiled automatically and feedback is provided to appropriate users based upon operations management metrics, failure analyses, or other business processes.

As is readily apparent to those of skill in the art, the above and other existing known systems and methodologies fail to provide a truly collaborative engineering and operations environment. None of these previous “collaborative” systems adequately addresses a logistic support system from product design to disposal. No system employs open architecture modules to follow the product from design concept to system requirements to manufacturing, to the supply chain, to obsolescence and disposal while providing real-time and continuous feedback regarding the performance of the individual outputs and the collective process.

There is, therefore, a need for a new type of collaborative operations system and method that allows shared data to remain in its native format without conversion to provide engineers and others access to current data in a format that is readily accessible by their individual systems, thereby providing the ability to share data efficiently and effectively.

### SUMMARY OF THE INVENTION

The present invention relates to a collaborative engineering and operations support system, and in particular to a collaborative system with open architecture modules that seamlessly integrate design, engineering, manufacturing, production, supply chain, training, and documentation module data into a coherent usable tool. The process enables data fusion across departments and organizations that are geographically separate by using an effective, lost cost integration method.

The method of the present invention allows users to maintain original processes for conducting their day to day activities, while at the same time preventing errors, handling data arbitration, and improving data visibility for decision makers. The method of the present invention does not require the user to add new software, re-train, or learn new processes.

The present invention manages information assets by integrating data throughout disparate departments and organizations. By including different departments and organizations under the collaborative environment umbrella, product and process knowledge is shared regardless of its native format. This permits the enterprise to respond quickly and agilely to challenges as they occur. Data is automatically culled from documents used in operations and enterprise management, and the pertinent data is automatically provided to users as it becomes available. Responsiveness to both internal and external customers is greatly facilitated by permitting interactive access to product information assets for all members of the enterprise. The collective enterprise has potential access to the latest information including design updates, development timelines, product specifications, product modeling and simulation, trade study, inventory management, enterprise resource planning, and other engineering tools. This mechanism for information exchange between disparate locations and tool sets provides a tighter design mechanism and improved enterprise management of the product throughout its life cycle.

Additionally, information assets such as designs, documentation, testing information, product history, and accumulated knowledge developed and utilized during the product life cycle may be re-used to facilitate consistency between products as well as to refine processes and assess metrics. The critical resources of the organization may then be leveraged throughout the enterprise as the disparate subject experts propagate their expertise throughout the enterprise. The challenges presented by rapidly evolving technologies, cost pressures, and short product delivery cycles may be met by extending the capabilities of single users throughout the enterprise. As tools, processes, knowledge, experience, and requirements change, the collaborative system of the present invention provides the ability to flexibly meet these requirements while conforming to core business rules.

### BRIEF DESCRIPTION OF THE DRAWINGS

The above-mentioned and other features and benefits of this invention and the manner of attaining them will become more apparent, and the invention itself will be better understood by reference to the following description of embodiments of the invention taken in conjunction with the accompanying FIGURES where:

FIG. 1 is an illustration of a collaborative systems engineering and advanced logistics support environment in accordance with one embodiment of the invention.

FIGS. 2A and 2B are flow diagrams illustrating basic operations of the invention.

FIG. 3 is a graphical representation of elements composing an asset life cycle as used in the present invention.

FIG. 3A is an illustration of modules composing the system of the present invention.

FIGS. 4A and 4B are flow diagrams illustrating methods of operation of the present invention.

### DETAILED DESCRIPTION OF THE INVENTION

The invention is described in detail with particular reference to certain preferred embodiments, but within the spirit and scope of the invention, it is not limited to such embodiments. It will be apparent to those of skill in the art that various features, variations, and modifications can be included or excluded, within the limits defined by the claims and the requirements of a particular use.

The present invention is directed to a system and method for collaborative systems engineering and logistics support. The system and method permit accurate tracking of assets from design to disposal and provide relevant data regarding the asset to users throughout the asset life cycle. The present invention is implemented by the use of an application program on computers at stations where individual contributors perform their various work tasks and where others performing roles within the asset life cycle have occasion to view pertinent documents and data regarding the asset.

Previous systems for collaborative systems engineering dictated asset tracking based upon that singular global system. With the present invention, stand alone applications programs may be replaced or upgraded without affecting the collaborative environment. The present invention enables the various individual contributors in the collaborative environment to utilize their personal applications while the systems engineering and advanced logistics system extracts data from the back end of the system. This enables future users, who may not use the same application program, to have access to legacy data objects. The data objects persist even if the application program with which they were created becomes outdated, or is replaced, or otherwise is no longer used in the collaborative environment.

A key advantage to the system of the present invention is that the user is not beholden to one program or one system or one manufacturer. The collaborative user is able to pick and choose programs based upon their features and advantages. True interoperability and connectivity is delivered by the system of the present invention. The method of the present invention allows a seamless connection of all the disparate applications used within a collaborative environment.

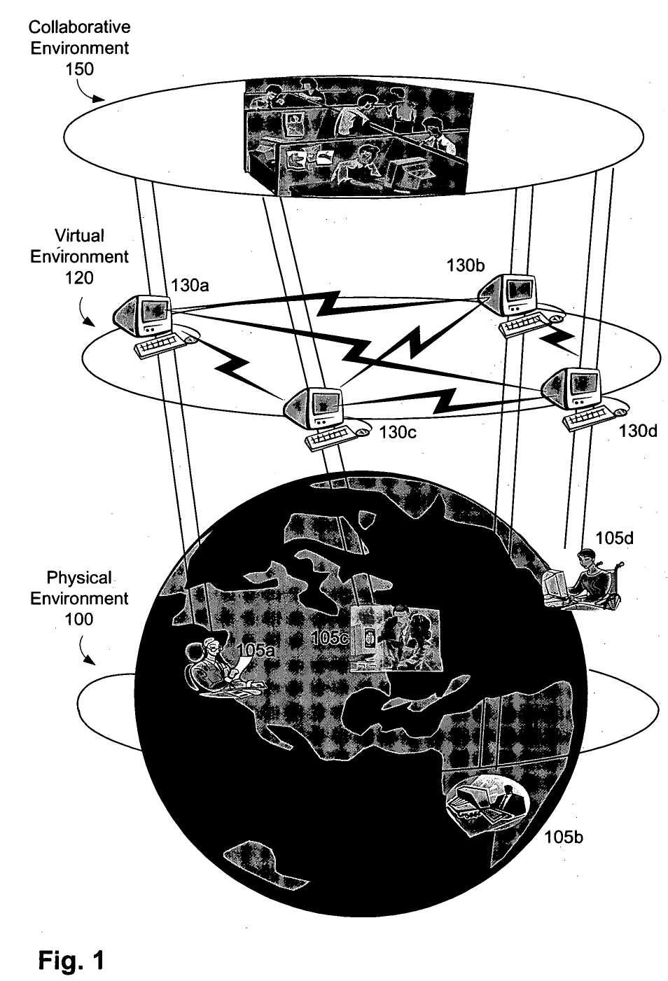

FIG. 1 illustrates a collaborative systems engineering environment 100 where individual contributors 105a, 105b, 105c, 105d may be located in different departments of a company, in different companies, in different cities, or in different countries throughout the world. For convenience and brevity, in FIG. 1 four individual contributors are shown, but an unlimited number of individual contributors may use the collaborative systems engineering environment depicted in FIG. 1. Each individual contributor 105 is responsible for an element of a final work product, and the ability of multiple contributors to work simultaneously on separate aspects of the final work product allows for a synergy of efforts resulting in a quicker completion of a better work product, with work assigned to individuals based upon their unique skill set. The individual contributors exchange relevant information and tools and collaborate through a communications network 120 that links these individual contributors together so that each individual contributor has access to the in-progress work product of the others through communication devices 130a, 130b, 130c, 130d such as computer systems, telephones, and other communication devices. The communication network 120 transforms the separate and disparate individual contributors into an integrated virtual office environment 150 in which each contributor has ready access to the other individual contributors and the work in progress. This integrated virtual office environment 150 permits completion of projects and output of a high quality final work product in an extremely efficient manner.

Overview

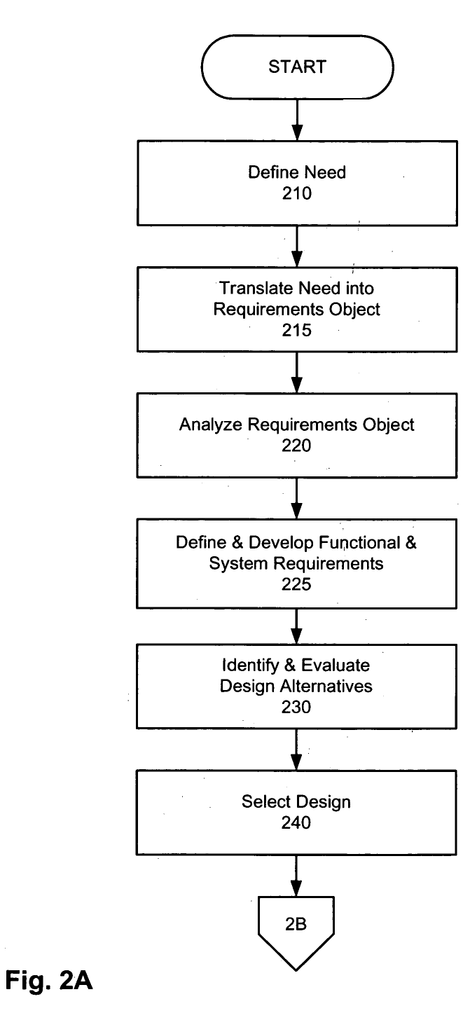

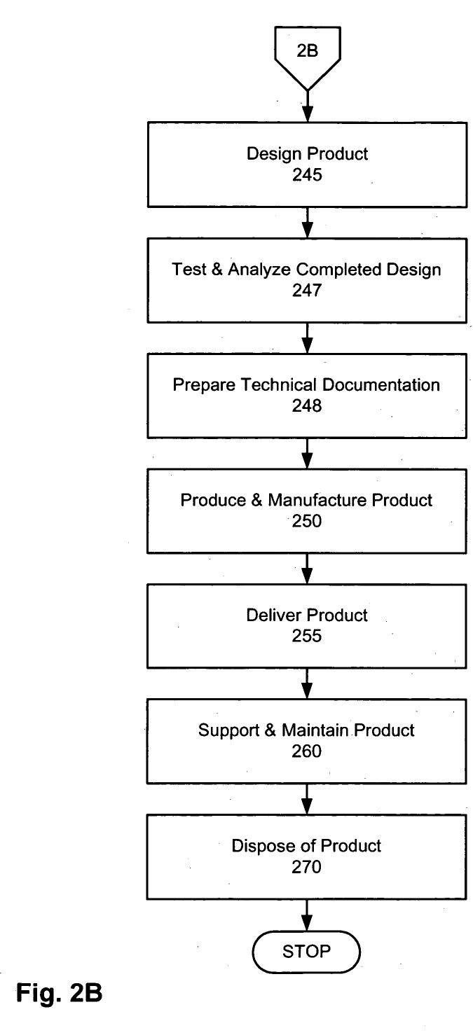

While software modules are described, it is to be understood that all or a portion of the exemplary embodiments can also be conveniently implemented by the preparation of application-specific integrated circuits or by interconnecting an appropriate network of component circuits. For simplicity and brevity, an exemplary embodiment utilizing software modules is shown in FIG. 2.

As illustrated in FIG. 2, the collaboration begins at step 210 when a problem or need is recognized. The problem may be recognized by any number of individuals, groups, or other institutional actors. Often a problem or need is recognized by a company's marketing department conducting market research or by a customer or potential customer that may desire a particular product with specific features or a general product to achieve a particular goal.

Once the problem or need is recognized, the collaborative systems engineering process continues at step 215 as the actors clarify the problem and articulate a requirements object. The requirements object is the result of translating the need or the answer to the recognized problem into a top-level solution. The top-level solution may include general functionality of a product, price targets, sales projections, required resources, and a life cycle schedule.

Once this requirements object is determined, it may be analyzed at step 220 and at step 225 pared down into various functional, system, and product requirements that serve to further define and constrain the design of the product. The group of collaborators determine a number of product design alternatives based upon the top-level solution and then evaluate the various design alternatives with regard to cost, quality, ease of manufacture, length of lead times, legal constraints, and any number of other design and manufacture specifications and process plans to arrive at the best design alternative at step 230. The users call upon their individual skill sets to reach a consensus and choose the best design alternatives within the parameters established by the various business rules of the company.

Once the best design alternative is chosen at step 240, engineers design the selected product at 245 by utilizing schematic and block diagrams, initial bills-of-materials, pre-prototype simulations, mechanical and computer modeling, and engineering and specialty design reviews. At 247, the engineers test and analyze the completed designs to ensure proper performance and verification in accordance with various business rules as well as to ensure that the finished product meets the requirements object initially set forth. Further, at step 248 the engineers prepare technical documentation including installation and field test manuals, calibration manuals, technical manuals, and user manuals to ensure the delivered product operates properly and within the parameters established by the requirements object and that the finished product may be properly serviced. Once the finished design has been properly tested and documented, production of the finished product occurs at 250. Production scheduling, management of supplier networks, output requirements, packaging and storage, and equipment and facilities must all be managed properly under the production umbrella. The finished goods are then delivered to the customer at 255 to complete the sale and distribution. Once the finished goods are in the customers' hands, the product must be installed and supported at 260, and warranty costs, service costs, performance data of the finished goods, and customer satisfaction must be monitored. As the product matures, on-going service may be required, and design refinements or upgrades are inevitable over the product life cycle as the product is continually evaluated during its useful life and the need for improvements and updates is realized. Once the product has reached the end of its useful life at 270, it must be disposed, and several options such as trading the product in, re-selling the product, recycling the materials, and scrapping the product are evaluated by the customer and by the organization to determine how each of the alternatives best fits within the business rules of the organization.

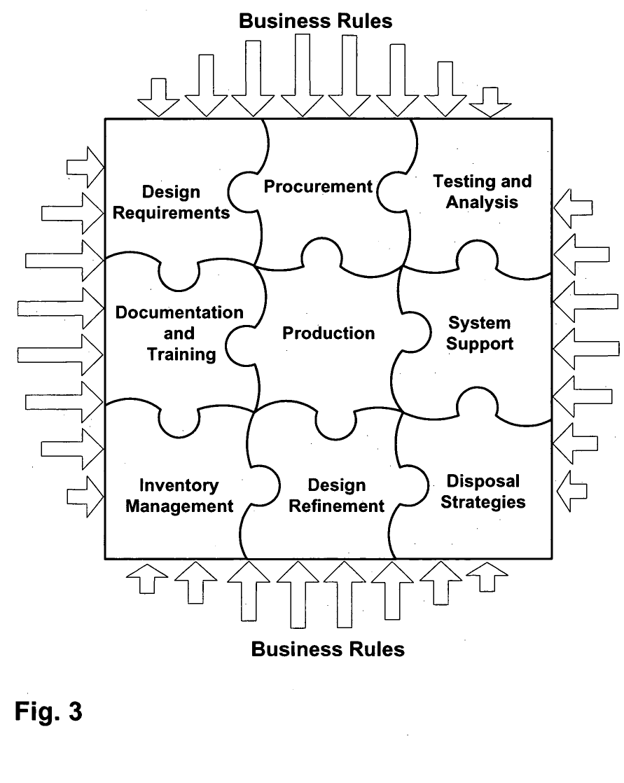

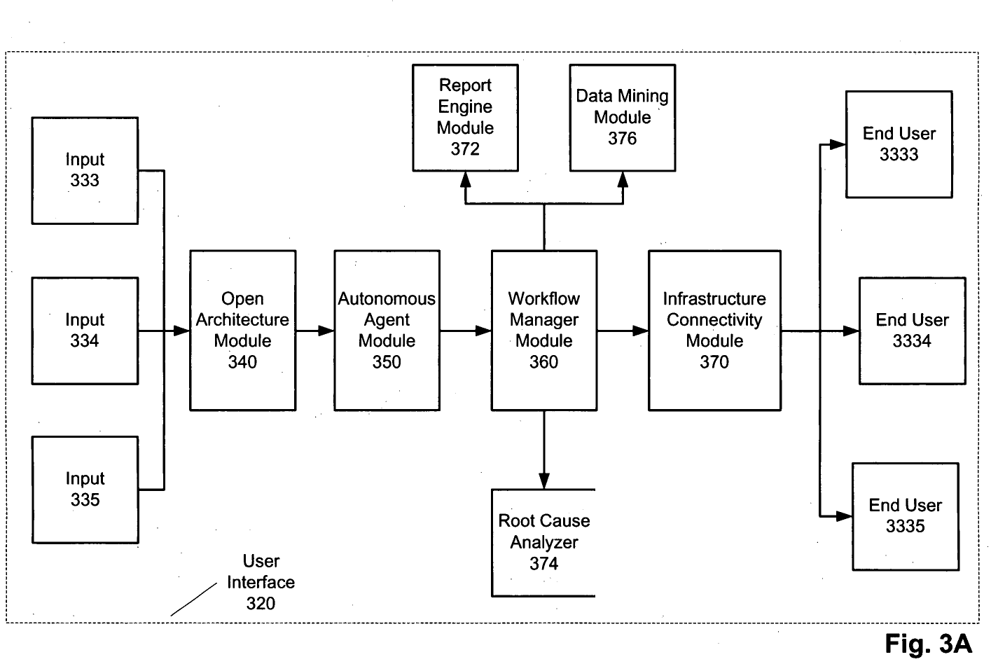

In FIG. 3, a graphical representation of pieces that compose the asset life cycle is shown. Business rules established by the organization exert pressure upon each of the component pieces throughout the life cycle of the asset. Each of the stages of the asset life cycle must conform to established business rules to ensure that the product will be viable for the organization.

At each point in the asset life cycle, a variety of users provide input to the processes involved. Each of the users may create documents or other data that is utilized to perform their specific work function and to add value to that piece of the asset life cycle. The information conveyed by these documents and data may later be used to make decisions that affect the asset further along its life cycle. The present invention provides a system and method with which the data utilized and the discrete work products generated by the individual contributors may be distributed and shared among the collective group performing work associated with the asset life cycle. The documents and work products contain underlying data characterizing the asset as it matures through its life cycle. Each user receives specific information regarding the asset that is pertinent to their own decision support processes to enable efficient and compatible assessments during the asset life cycle and to optimize future decisions regarding the asset.

Documents and data utilized by the present invention are accessed by a communications network such as an intranet or the Internet to afford all users simultaneous access to the system and to the data. Similarly, proprietary networks, databases, and servers may also be used as the distributed computer system as long as all users may access the system to collaboratively manage and track the asset.

Example of Operation

To best understand the present invention, it is useful to track an asset through its life cycle and to examine the documents and data that touch or concern the particular asset and to then see how this data is shared throughout the enterprise by use of the system and method of the present invention.

In tracking an asset through the system, at each step documents and data are created and examined. The structure of the collaborative system of the present invention provides software modules that perform the data creation, routing, analysis, storage, and other functions that form the backbone of the engineering and advanced logistics support activities. These modules are shown in FIG. 3A, and portions of each of the modules may be used in all of the steps of performing the method of the present invention. The modules include an open architecture module 340 that provides data in its native format, an autonomous agent module 350 that sets and responds to trigger criteria and independently gathers data provided by the open architecture module 340 and processes tasks in the background, a workflow manager module 360 that polices and enforces business rules in data routing so that individual departments, organizations, and individuals are notified that the data was provided by the open architecture module 340 and performs specific tasks in an order in accordance with the business rules established by the autonomous agent module 350, an infrastructure connectivity module 370 that provides a notification pathway for the workflow manager module 360 to route data by establishing and maintaining communication links between the individuals, departments, and organizations to allow collaboration, a report engine module 372 for extracting, formatting, and delivering data routed by the workflow manager module 360, a root cause analyzer module 374 that analyzes data routed by the workflow manager module 360, sets an alarm level to detect unwanted occurrences in the data, sets exclusions for the detection of unwanted data, determines the cause of the unwanted occurrence, and removes the cause of the unwanted occurrence, a data mining module 376 that analyzes data routed by the workflow manager module 360 to databases using tools and applications that look for trends and anomalies in the data, and a user interface 320 to access the open architecture module 340, the autonomous agent module 350, the workflow manager module 360, the infrastructure connectivity module 370, the report engine module 372, the root cause analyzer module 374, and the data mining module 376.

Define a Need 410

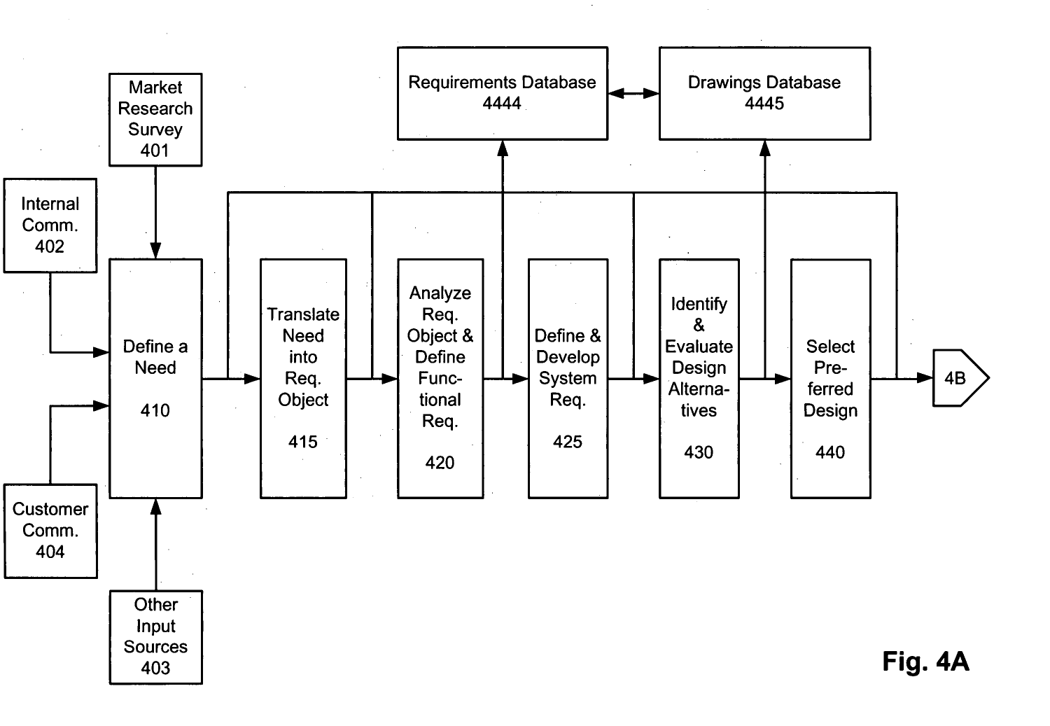

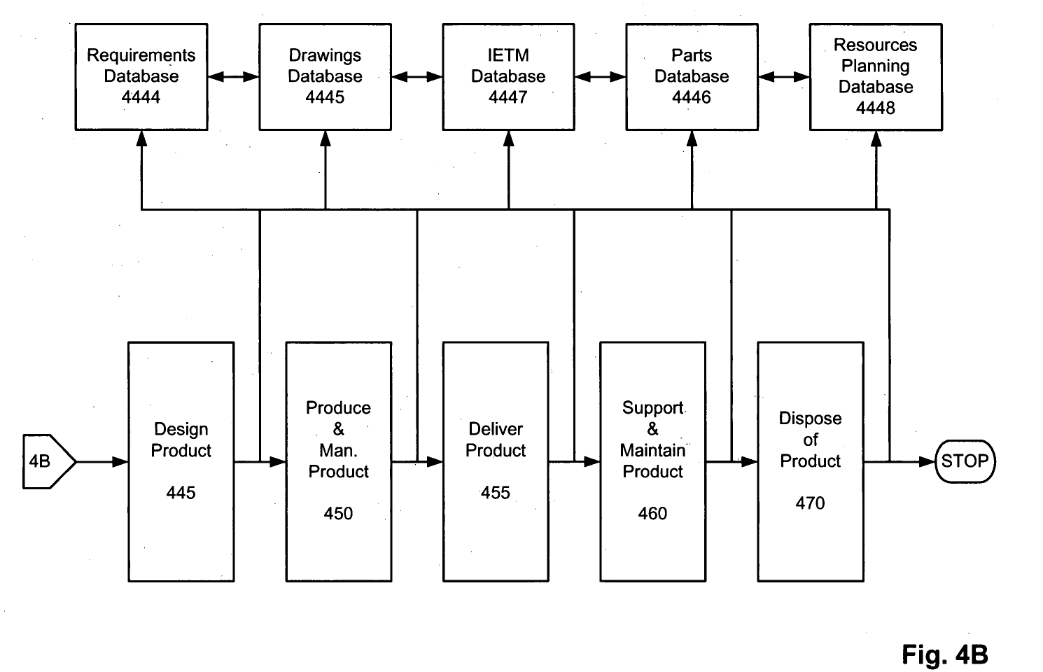

Referring to FIG. 4A, the asset life cycle begins when a problem or need is recognized 410. The problem or need may be recognized as the result of a market survey 401 or a customer communication 404 or request or simply as the result of a memorandum 402 from one employee to another. Whatever the input that serves to identify the problem or need, the input can be stored as a document or converted to a document if the communication was by some other means 403. The user, such as a marketing employee or other individual contributor, names and stores the document in its native format in a requirements database 4444 where it may be accessed by other users in the enterprise through the distributed computing environment.

By using the open architecture module 340 previously described with regard to FIG. 3A, the present invention presents users with documents in their native format, or if the native format of the document may not be utilized by the particular collaborative team member, the document or data object is presented in a standardized format according to the applications employed by the user. With the native format, or the standardized format, the users may locate and utilize pertinent data objects without searching through the organization. The present invention employs business rules described and warehoused in the autonomous agent module 350 of the organization to determine how the workflow manager module 360 delivers data objects and to whom the data objects are to be delivered.

Returning to FIG. 4A, as the market research report 401 document or customer communication 404 is stored in the requirements database 4444, the document is assigned a file number. The present invention strips down and parses the data elements in the document into discrete data objects. The documents are parsed using both lexical analysis and semantic parsing. Lexical analysis focuses upon dividing the relevant document strings into generic tokens based on punctuation and other keys factors. These are the data objects. The document strings are then analyzed semantically to determine the meaning of the string and what the data elements represent. The invention then tags the data objects for reference, and assigns an owner, normally the creator of the document, to each discrete data object. The invention then inserts the data objects into database structures in the requirements database 4444.

For example, a customer communication is sent to the marketing group expressing a need for the world's fastest submarine. The marketing manager stores the customer communication document in the requirements database 4444, and it is given a unique file name or other identification number that is used throughout the entire asset life cycle. Further, the date, time in hours, minutes, and seconds, is noted to ensure that collaborative documents are updated appropriately and that a collaborating user always is cognizant of the version with which they are working. As the document is stored, the data is stripped from the document and parsed into discrete data objects, one of which is the speed requirement. A one-to-many mapping is created. The marketing manager is assigned as owner of this data object.

In this fashion, data objects of relevance to particular users or groups of users may be distributed based upon an owner or a user establishing a trigger criteria. Data trends may also be analyzed and users alerted to trends as they become evident.

Translate Need into Requirements Object 415

Continuing in FIG. 4A, upon completion of this definition of a need, the need is translated into a requirements object, which is a high-level solution to the identified problem or need. The requirements object may be a concept of a solution, for example. In this instance, the present invention takes the speed requirement data object and automatically sends the document and the data object to the marketing group, the future projects group, the engineering management group, and others who possess unique skills necessary to formulate a conceptual solution to the customer's need and the requirements object. The present invention employs the workflow management module and the infrastructure connectivity module to deliver the data objects to the disparate groups and users over the distributed computer network in a format that is usable by the recipient. These disparate groups may then collaborate with each other over the distributed computing environment and come to a consensus with regard to a final requirements object. The communications between the collaborative group, such as emails, memos, sketches, FIGURES, and other communiqués, and the documents created and accessed during the consensus-building are also stored in the requirements database 4444. These may include various proposals attempting to identify a requirements object and will ultimately include the consensus solution. Discrete data objects are also culled from these communiqués and delivered to appropriate team members in the collaborative environment by the present invention. In the example of a submarine that must be the world's fastest, the requirements object may be a submarine that travels in excess of 50 knots, that has a range of 10,000 kilometers, is manned by a crew of less than 100 seamen, and costs less than $10 million to produce. These discrete data objects are parsed from the documents outlining the requirements object and distributed throughout the collaborative environment in a useable format and stored in the requirements database.

Analyze Requirements Object and Define Functional Requirements 420

Once the requirements object is determined, it is analyzed and broken down into more modular functional requirements. The functional requirements describe systems and subsystems that in total satisfy the requirements object. Functional requirements may be described in flow string diagrams or other documents and data objects that are then parsed and stored in the requirements database 4444.

Define and Develop System Requirements 425

The functional requirements are then translated into product and system requirements by defining the functions that the system and subsystems must perform to achieve the desired outputs, by defining interfaces between the functions, and by defining the requirements associated with each of the functions. In the submarine example, product requirements may include a steel hull that is less than 100 meters long and more than 20 meters wide, a propeller screw that is less than 5 meters in diameter, and a nuclear reactor capable of providing 200 MW of power to drive the submarine. Each of the product requirements documents is stored in the requirements database 4444 and parsed to pull discrete data objects from the document as a whole. These data objects may include information relating to the propulsion system, the defense system, the navigation system, and other key system subcomponents that may be logically separated from one another to provide discipline-specific bounds within which the different collaborating team members may operate. The documents are stored in the requirements database 4444, and the invention delivers the data objects to appropriate users collaborating on the project. As the collaboration progresses, each user may add data objects or create new documents with additional information and additional data objects. For example, in addition to the requirement that the propeller screw be less than 5 meters in diameter, an engineering team collaborating on the project may also dictate the size, shape, and weight of the propeller screw, and employ the system of the present invention to link these additional product requirements as data objects to a variety of the functional objects describing the systems. These new data objects are then stored in the requirements database 4444 and distributed to appropriate users.

Identify & Evaluate Design Alternatives 430

Once the functional and system requirements are defined, the collaborative team performs studies and analyses to refine and optimize performance requirements for each of the subsystems. The team defines evaluation criteria, describes the approaches to the studies, performs the evaluations, documents the results of the evaluations, and then selects the preferred system design according to their findings. At each point in the evaluation process, mechanical drawings, modeling procedures, historical data, test procedures, test results, and analyses documents may be used to substantiate the integrity of the evaluations as well as the integrity of the ultimate selection of the chosen design. These documents comprise data objects that relate to each of the examined criteria as well as to the observed results. With the propeller example, each propeller design is given a unique tracking number and stored in the drawings database 4445 and parts database 4446. Additionally, the documents associated with the evaluation, as well as data objects relating to the propeller design, such as diameter, pitch, cupping, rake, and other objects are all stored in the same drawings database 4445 and parts database 4446 and are linked to the unique tracking number assigned to the particular propeller design. Each of the data objects corresponding to analyzed design variables are parsed and stored in the parts database 4446 and similarly linked to the appropriate evaluation document. Similarly, other propeller designs considered would also be given a unique tracking number, and the documents and data objects corresponding to those designs are likewise stored in the drawings database 4445 and parts database 4446 and linked with their unique tracking numbers.

Select Preferred Design 440

The team of collaborators determine a number of product design alternatives and evaluate the various design alternatives with regard to cost, quality, ease of manufacture, length of lead times, legal constraints, and any number of other design, manufacturing, and production variables to arrive at the best design alternative. The users call upon their individual skill sets to collaborate and to reach a consensus and choose the best design alternative within the parameters established by the various business rules of the company and implemented by the underlying autonomous agent module. The consensus decision is memorialized in any number of documents that are stored in the requirements database 4444 and the drawings database 4445, with the data objects parsed and stored accordingly.

Design Product 445

Once the best conceptual design alternative is chosen, engineers design the selected product and parts of the product by utilizing Computer Assisted Design (CAD) systems to draw and build schematic and block diagrams, initial bills-of-materials, pre-prototype simulations, mechanical and computer models, and engineering and specialty design review documents. The engineers test and analyze the completed designs to ensure proper performance and verification in accordance with the various business rules as well as to ensure that the finished product meets the requirements object initially set forth. Data objects from the product design may be compared to those stored in the requirements database 4444 to ensure compliance. If the collaborative team approves the prototype design drawing, the elements comprising the parts drawings are assigned part numbers and stored in the parts database 4446 as data objects. Likewise, the composite drawings are also stored in the drawings database 4445 and linked to the data objects that comprise the drawings. These CAD drawings are then used to compile a functional bill of materials to which the propeller may be manufactured. If necessary, CAD drawings may be used to produce tooling drawings to be used in conjunction with a Computer Assisted Manufacturing (CAM) system to fabricate the parts.

Test & Analyze Completed Design 447

Once the design is complete, the finished product is tested to ensure it meets performance, interoperability, reliability, packaging, and cost requirements. Members of the collaborative team analyze performance test criteria and resulting test data and then evaluate the results. Interoperability must be evaluated to ensure the finished product will properly function with existing components. The propeller screw must properly fit on the drive shaft. Tolerances must coincide and function properly. Reliability checks and redundancy evaluations are performed to ensure the product lasts for its designed lifecycle. Packaging tests may be necessary to ensure the finished product is within size and weight requirements and can withstand potentially hazardous shipping or delivery conditions to arrive in pristine condition for installation. Shipping containers for the propellers must be fabricated and tested for fit and durability. Cost considerations are factored in throughout the testing and analysis process to ensure that the finished product is delivered within budgetary constraints.

Data objects associated with these test plans and the test results are extracted by the invention and stored in the parts database 4446 and the drawings database 4445. Similarly, data objects related to ancillary items such as shipping containers are also tagged and extracted. Within this environment, the organization is able to eliminate potential problems years down the road when an older propeller might be produced and no one in the organization knows who made the shipping crate or how large it had to be. This type of institutional knowledge is preserved by storing the data objects related to the various products and parts. Similarly, the data objects are also linked to the requirements database 4444 for active comparisons to initially established requirements objects and performance constraints. Data objects of particular relevance are again extracted and sent to the concerned collaborators for further review and implementation as the process iterates.

Prepare Technical Documentation 448

The collaborating team prepares technical documentation including installation and field test manuals, calibration manuals, technical manuals, and user manuals to ensure the manufactured product operates properly and within the parameters established by the requirements object and that the finished product may be properly serviced. The technical documentation is then stored in the Interactive Electronic Technical Manual (IETM) database 4447. The IETM is stored on a computer server, a CD-ROM, an HTML page, or on other means by which it may be accessed to provide user interactivity. The IETM database 4447 is linked to the parts database 4446 and the drawings database 44445 and provides hyperlinks to technical documents, parts lists, and drawings via the relational characteristics of the databases. The neural intelligence of expert systems is embodied in the IETM as it provides interactive assistance in installation and troubleshooting while eliminating paper copies of technical manuals. The IETM also ensures version control of referenced FIGURES, tables, drawings, procedures and other trouble-shooting instructions as the documents are stamped and coded with accurate version data objects.

The IETM enables the user to hyperlink directly to a referenced item and access drawings, parts lists, bills of materials, technical notices, and other documents related to a particular part or subsystem. Additionally, in trouble-shooting sections of the electronic manuals, the user can highlight the current problem, and the IETM will then provide step-by-step instructions aimed at resolving the issue. The IETM does this by specifying sequential trouble-shooting tests and the possible results of the test and then branching the user to the next step of the logical troubleshooting process based upon the reported results. By providing this functionality, the IETM enables a user to access collaborative resources of the engineering and systems teams in the most relevant manner directed to the issue at hand. Additionally, failure data culled from performance of the installation checks and troubleshooting process may be used by the IETM expert system to provide additional assistance to future users. Likewise, data objects related to installation, calibration, and troubleshooting can provide insight as to the manufacturability of the individual products and subsystems as the individual items are related to cost data.

Produce and Manufacture Product 450

Once the finished design has been properly tested and documented, production of the finished product occurs. The final design and technical documents are formalized and are used in conjunction with a CAM system to fabricate the necessary parts that make up the product system, subsystem, or part. Production documents include orders of raw materials, bills of lading, invoices for raw materials, producer and supplier communications, production schedules, production outputs, production testing documents, equipment and facilities schedules, quality assurance tests and results, employee schedules, and other documents necessary to track and turn raw materials into the finished product. The required resources that are inputs to the collaboration comprise a vast trail of documents characterizing the production process and forming a store of institutional knowledge and experience related to the product or subsystem.

The invention tracks the inputs from the initial customer inquiry or sales order to outbound shipments to customers by extracting data objects from the documents and notifying collaborative users of key objects. These documents are stored in the resources planning database 4448, and the data objects comprising the elements are parsed and linked via the parts database 4446 to the physical parts used in production and output as finished goods. Materiel resource planning efforts include demand planning to determine the priority in which customer orders are filled using capacity and time constraints. Inventory planning is also a part of materiel resource planning efforts and is used to develop and implement inventory processes to meet customer demands using service targets, budgets, stock out probabilities, and cost rates. Procurement planning analysis further examines utilization of multiple suppliers to allay stock-out risks, cost variations, and single-supplier problems, and production planning focuses on deftly shifting production based upon individual product demand. Additionally, production scheduling, management of supplier networks, output requirements, packaging and storage, and equipment and facilities must all be managed properly under the production rubric requiring large numbers of documents and data objects as tools by which the processes may be managed.

In the submarine example, demand planning may include the number of propellers required and the due date of the orders as well as other factors such as contractual penalties or discounts specified in the terms of the contract for late or early delivery. Additional financial factors such as tax rates on in-process inventory and other key cost elements must also be considered. An order for the propeller may include documents related to the part required, the date ordered, the date delivered, the schedule of payments, and other factors. Data objects from the purchase order, purchase confirmation, invoice, payment remittance, and other procurement papers are harvested from the documents and stored in the various databases. Data objects from these documents of particular relevance are delivered directly to the appropriate users in their native format or in a convenient format with which the user may access them.

Likewise, data objects from documents related to inventory management are delivered to appropriate collaborative users to permit the enterprise to meet customer demands while aligning the timing of cash inflows and outflows to maximize their cash position. Procurement documents comprise data objects necessary to evaluate shipment accuracy, rejected goods, payment timing and are also used to evaluate suppliers, manage cash flows, and conserve financial and human capital. Further, production planning documents may be used to model production costs as well as to allocate human resource requirements.

Deliver Finished Product 455

Once the finished goods are produced, they are packaged and shipped to the customer. Once the propeller is completed, it is packed in a custom crate designed using data objects related to the size, weight, volume, and geometry of the propeller. The data objects regarding the size, weight, volume, and geometry of the propeller were automatically delivered by the present invention to the design engineering and shipping departments. The data objects were utilized in their native format by the shipping department so the dimensions of the propeller were known, and a suitable shipping container could be procured. Shipping orders, bills of lading, carrier regulations, and a variety of other shipping information are also stored in the resources planning database 4448. Delivery confirmation, receipts, invoice copies, and other delivery information is also stored in the resources planning database 4448 and accessible by the collaborative team. The finished goods are then delivered to the customer to complete the sale and distribution of the product.

The data objects from the shipping and delivery documents are distributed to appropriate collaborative team members. For example, sales and management personnel receive delivery confirmation objects to ensure customer delivery deadlines were met. Accounting personnel also receive data objects gleaned from the delivery documents to trigger billing activities and inventory management. Procurement personnel receive similar data objects to trigger reorder point measurements and other materiel acquisition activities.

Support and Maintain Product 460

Once the finished goods propeller is in the customers' hands, it must be installed and supported, and installation costs, warranty costs, service costs, performance data regarding the finished goods, and customer satisfaction must be monitored. Propeller installation documents, field test measurements, regulatory compliance, and customer acceptance documents all serve to form a picture of the initial success of the product. These documents are parsed for data objects relating to the initial quality of the goods received, test performance of the finished goods, timeliness of installation, and ability of the finished goods to meet acceptance criteria. These data objects are then stored in the appropriate resources planning database 4448, drawings database 4445, parts database 4446, IETM database 4447, and requirements database 4444.

Over time, service of the propeller is required, and failure and service data generate data objects related to mean-time-between failures (MTBF), mean time to repair (MTTR), failure modes, fault tree analysis, and effects analysis. MTBF and MTTR data form a reliability picture of the propeller screw, while fault tree analysis and effects analysis may be used to predict future use availability and future performance of the propeller. Maintenance costs may be estimated using costs of materiel and labor charges to repair the propeller. Costs of operating the system may be calculated using data objects related to system availability and uptime. Spare and replacement parts inventory levels and strategies may be assessed by evaluating these data objects as well.

As the product matures, on-going service may be required, and design refinements or upgrades are inevitable over the product life cycle as the product is continually evaluated during its useful life and the need for improvements and updates is realized. Secondary markets for the products may be explored, refurbishment versus replacement decisions may be evaluated, and costs of operation are continually updated by using data objects culled from service and repair history, preventive maintenance sessions, and periodic performance tests.

Dispose of Product 470

Once the product has reached the end of its useful life, it must be disposed, and several options such as trading the product in, re-selling the product, recycling the materials, and scrapping the product are evaluated by the customer and by the organization to determine how each of the alternatives best fits within the business rules of the organization. Data objects portraying the useful life of the product are used by the collaborators in assessing the disposal options. Acquisition cost data, depreciation schedules, replacement costs, refurbishment outlays, insurance notifications, costs of the disposal options, and other data regarding disposing of the asset are used by individual contributors in the collaborative environment to best assess disposal options and to again agree upon a consensus disposal strategy. Data objects stored in the databases are delivered to the users assist in the decision process.

For example, the nature and history of the particular propeller may be evaluated to determine reliability and whether it should be accepted for a trade-in. Re-selling the propeller may be another possibility as markets may show demand for these particular systems. Likewise, scrapping the item or refurbishing the propeller also present disposal options for the organization and customer. By extracting the data elements from the relevant historic documents related to cost, performance history, and disposal options, a user may best decide and choose the appropriate disposal strategy for the particular propeller asset.

After step 470, the method for collaborative systems engineering and advanced logistics support concludes, and users and individual contributors may continue to work on additional projects.

The devices and subsystems of the exemplary embodiments can communicate, for example, over a communications network, and can include any suitable servers, workstations, personal computers (PCs), laptop computers, PDAs, Internet appliances, set top boxes, modems, handheld devices, telephones, cellular telephones, wireless devices, other devices, and the like, capable of performing the processes of the disclosed exemplary embodiments. The devices and subsystems, for example, can communicate with each other using any suitable protocol and can be implemented using a general-purpose computer system, and the like. One or more interface mechanisms can be employed, for example, including Internet access, telecommunications in any suitable form, such as voice, modem, and the like, wireless communications media, and the like. Accordingly, communications networks employed can include, for example, wireless communications networks, cellular communications networks, satellite communications networks, Public Switched Telephone Networks (PSTNs), Packet Data Networks (PDNs), the Internet, intranets, hybrid communications networks, combinations thereof, and the like. In addition, the communications networks employed can be the same or different networks.

As noted above, it is to be understood that the exemplary embodiments are for representative purposes, as many variations of the specific hardware used to implement the disclosed preferred embodiments are possible. For example, the functionality of the devices and the subsystems of the exemplary systems can be implemented via one or more programmed computer systems or devices. To implement such variations as well as other variations, a single computer system can be programmed to perform the special purpose functions of one or more of the devices and subsystems of the exemplary systems. On the other hand, two or more programmed computer systems or devices can be substituted for any one of the devices and subsystems of the exemplary systems. Accordingly, principles and advantages of distributed processing, such as redundancy, replication, and the like, also can be implemented, as desired, for example, to increase the robustness and performance of the exemplary embodiments.

The exemplary embodiments can be used to store information relating to various processes described herein. This information can be stored in one or more memories, such as a hard disk, optical disk, magneto-optical disk, RAM, and the like, of the devices and sub-systems of the exemplary systems. One or more databases of the devices and subsystems can store the information used to implement the exemplary embodiments. The databases can be organized using data structures, such as records, tables, arrays, fields, graphs, trees, lists, and the like, included in one or more memories, such as the memories listed above.

All or a portion of the exemplary embodiments can be conveniently implemented using one or more general-purpose computer systems, microprocessors, digital signal processors, micro-controllers, and the like, programmed according to the teachings of the disclosed exemplary embodiments. Appropriate software can be readily prepared by programmers of ordinary skill based on the teachings of the disclosed exemplary embodiments. In addition, the exemplary systems can be implemented by the preparation of application-specific integrated circuits or by interconnecting an appropriate network of component circuits.

While the present invention have been described in connection with a number of exemplary embodiments and implementations, the present invention is not so limited but rather covers various modifications and equivalent arrangements, which fall within the purview of the appended claims.

1. A system for collaborative engineering, said system comprising:
an open architecture module that provides data in its native format;
an autonomous agent module that sets business rules, sets and responds to trigger criteria, and gathers the data provided by the open architecture module;
a workflow manager module that polices and enforces the business rules in data routing so that individual departments, organizations, and individuals are notified that the data was provided by the open architecture module and performs specific tasks in an order in accordance with the business rules established by the autonomous agent module;
an infrastructure connectivity module that provides a notification pathway for the workflow manager to route data by establishing and maintaining communication links between the individuals, departments, and organizations to allow collaboration;
a report engine module for extracting, formatting, and delivering data routed by the workflow manager module;
a root cause analyzer module that analyzes data routed by the workflow manager module, sets an alarm level to detect unwanted occurrences in the data, sets exclusions for the detection of unwanted data, determines the cause of the unwanted occurrence, and removes the cause of the unwanted occurrence;
a data mining module that analyzes data routed by the workflow manager module to a database using tools and applications that look for trends and anomalies in the data; and
a user interface to access the open architecture module, the autonomous agent module, the workflow manager module, the infrastructure connectivity module, the report engine module, the root cause analyzer module, and the data mining module.

2. The system for collaborative engineering of claim 1, wherein the autonomous agent module analyzes the data and compiles trend information regarding the data.

3. The system for collaborative engineering of claim 2, wherein the autonomous agent module executes a predetermined action if the trend information meets a trigger criterion.

4. The system for collaborative engineering of claim 3, wherein the predetermined action is to notify a designated user that the trend information met the trigger criteria.

5. The system for collaborative engineering of claim 3, wherein the predetermined action is to execute a change affecting at least one of the group consisting of: the open architecture module, the autonomous agent module, the workflow module, the infrastructure connectivity module, the report engine module, the root cause analyzer module and the data mining module.

6. A system for collaborative engineering, said system comprising:
a first data module that provides data in its native format;
a second data module that sets business rules, sets and responds to trigger criteria, and gathers the data provided by the first module; and
a third module that polices and enforces the business rules in routing data so that individual departments, organizations, and individuals are notified that the data was provided by the first module, the third module performing specific tasks in an order in accordance with the business rules established by the second module.

7. The system for collaborative engineering of claim 6, wherein the second data module further comprises:
a first sub-module that analyzes the data and compiles trend information regarding the data.

8. The system for collaborative engineering of claim 7, wherein the second data module executes a predetermined action if the trend information meets a trigger criterion.

9. The system for collaborative engineering of claim 8, wherein the predetermined action is to notify a designated user that the trend information met the trigger criteria.

10. The system for collaborative engineering of claim 8, wherein the predetermined action is to execute a change affecting at least one of the group consisting of: the open architecture module, the autonomous agent module, the workflow module, the infrastructure connectivity module, the report engine module, the root cause analyzer module and the data mining module.

11. A method for collaborative systems engineering, said method comprising the steps of:
identifying an author of a resource;
storing the resource in a native format from which the author created the resource;
converting the resource into discrete data objects;
identifying users of the data objects and the applications that each user requires to use the data objects;
creating a network of pathways linking the author of the resource and the users of the data objects together with applications necessary for each of the users to access and use the data objects; and
delivering the data objects to each of the users with applications necessary for each of the users to access and use the delivered data objects.

12. The method for collaborative systems engineering of claim 11 further comprising analyzing the data objects and compiling trend information regarding the data objects.

13. The method for collaborative systems engineering of claim 12, further comprising executing a predetermined action if the trend information meets a trigger criterion.

14. The method for collaborative systems engineering of claim 13, wherein the predetermined action is to notify a designated user that the trend information met the trigger criteria.

15. The method for collaborative systems engineering of claim 13, wherein the predetermined action is to execute a change affecting at least one of the group consisting of: the open architecture module, the autonomous agent module, the workflow module, the infrastructure connectivity module, the report engine module, the root cause analyzer module and the data mining module.

16. A method for collaborative systems engineering, said method comprising the steps of:
creating a requirements object for a project;
creating a requirements function for an element of the project based upon the requirements object;
identifying a subsystem of the project that performs the requirements function;
identifying components included in the subsystem;
associating document files to the requirements function based upon the relationship of the document files to the requirements object;
converting the document files into discrete data objects;
identifying authors of the data objects and the applications that each author requires to create the document files;
identifying users of the data objects and the applications that each user requires to use the data objects;
creating a network of pathways linking the authors of the documents and the users of the data objects together with applications necessary for each of the users to access and use the data objects; and
delivering the data objects to each of the users with applications necessary for each of the users to access and use the delivered data objects.

17. The method for collaborative systems engineering of claim 16 further comprising analyzing the data objects and compiling trend information regarding the data objects.

18. The method for collaborative systems engineering of claim 17, further comprising executing a predetermined action if the trend information meets a trigger criterion.

19. The method for collaborative systems engineering of claim 18, wherein the predetermined action is to notify a designated user that the trend information met the trigger criteria.

20. The method for collaborative systems engineering of claim 18, wherein the predetermined action is to execute a change affecting at least one of the group consisting of:
the open architecture module, the autonomous agent module, the workflow module, the infrastructure connectivity module, the report engine module, the root cause analyzer module and the data mining module.

21. A method for collaborating in a systems engineering enterprise, said method comprising the steps of:
creating a document for use in determining an asset life cycle including design, production, distribution, support, and disposal scenarios;
coding the document with author information, user information, and business process information;
storing the document in a database;
linking the document in the database to the business process information relating to activities performed by the enterprise during the asset life cycle;
delivering data contained in the document from the database to a user based upon the user information and in response to triggers established based upon the business process information.

22. The method for collaborating in a systems engineering enterprise of claim 21, wherein prior to the step of storing document in the database, the document is converted to a binary stream and stored in that format.

23. The method for collaborating in a systems engineering enterprise of claim 21, wherein prior to the step of storing document in the database, the document is converted to an XML string and stored in that format.

24. A collaborative method of specifying, designing, producing, delivering, monitoring, supporting, and retiring products and processes in a business enterprise by effectively managing elements in a systems engineering and advanced logistic support chain from design to disposal, the method comprising:
creating a requirements object for individual elements of the systems engineering and advanced logistic support chain outlining the purpose of each element, the contexts in which the element will be used, and constraints imposed upon the element;
creating at least one document describing the requirements object and linking the requirements object with affected elements of the chain and with users of the requirements object through a requirements database;
creating a requirements function for an element of the chain based upon the requirements object;
identifying a subsystem of the element that performs the requirements function;
identifying components included in the subsystem;
updating the requirements database to link the requirements object to the users of the requirements object, the document describing the requirements object, the elements of the chain, the subsystem of the element that performs the requirements function, and the components included in the subsystem; and
associating the at least one document file to the requirements function, the subsystem, and the plurality of components included in the subsystem based upon the relationship of the document file to the requirements object.

25. A data storage medium with computer-executable instructions for performing collaborative systems engineering, the data storage medium comprising:
instructions for identifying an author of a resource;
instructions for storing the resource in a native format from which the author created the resource;
instructions for converting the resource into discrete data objects;
instructions for identifying users of the data objects and the applications that each user requires to use the data objects;
instructions for creating a network of pathways linking the author of the resource and the users of the data objects together with applications necessary for each of the users to access and use the data objects; and
instructions for delivering the data objects to each of the users with applications necessary for each of the users to access and use the delivered data objects.

26. The data storage medium with computer-executable instructions of claim 25 further comprising instructions for analyzing the data objects and compiling trend information regarding the data objects.

27. The data storage medium with computer-executable instructions of claim 26, further comprising instructions for executing a predetermined action if the trend information meets a trigger criterion.

28. The data storage medium with computer-executable instructions of claim 27, wherein the instructions for executing a predetermined action further comprise instructions for notifying a designated user that the trend information met the trigger criteria.

29. The data storage medium with computer-executable instructions of claim 27, wherein the instructions for executing a predetermined action further comprise instructions for executing a change affecting at least one of the open architecture module, the autonomous agent module, the workflow module, the infrastructure connectivity module, the report engine module, the root cause analyzer module, or the data mining module.

30. A workstation for administering collaborative systems engineering, the workstation comprising:
an open architecture module that provides data in its native format;
an autonomous agent module that sets business rules, sets and responds to trigger criteria, and gathers the data provided by the open architecture module;
a workflow manager module that polices and enforces the business rules in data routing so that individual departments, organizations, and individuals are notified that the data was provided by the open architecture module and performs specific tasks in an order in accordance with the business rules established by the autonomous agent module;
an infrastructure connectivity module that provides a notification pathway for the workflow manager to route data by establishing and maintaining communication links between the individuals, departments, and organizations to allow collaboration;
a report engine module for extracting, formatting, and delivering data routed by the workflow manager module;
a root cause analyzer module that analyzes data routed by the workflow manager module, sets an alarm level to detect unwanted occurrences in the data, sets exclusions for the detection of unwanted data, determines the cause of the unwanted occurrence, and removes the cause of the unwanted occurrence;
a data mining module that analyzes data routed by the workflow manager module to a database using tools and applications that look for trends and anomalies in the data; and
a user interface to access the open architecture module, the autonomous agent module, the workflow manager module, the infrastructure connectivity module, the report engine module, the root cause analyzer module, and the data mining module.

31. The workstation of claim 30, wherein the autonomous agent module analyzes the data and compiles trend information regarding the data.

32. The workstation of claim 31, wherein the autonomous agent module executes a predetermined action if the trend information meets a trigger criterion.

33. The workstation of claim 32, wherein the predetermined action is to notify a designated user that the trend information met the trigger criteria.

34. The workstation of claim 32, wherein the predetermined action is to execute a change affecting at least one of the open architecture module, the autonomous agent module, the workflow module, the infrastructure connectivity module, the report engine module, the root cause analyzer module, or the data mining module.

35. A workstation for administering collaborative systems engineering, the workstation comprising:
a first data module that provides data in its native format;
a second data module that sets business rules, sets and responds to trigger criteria, and gathers the data provided by the first module; and
a third module that polices and enforces the business rules in routing data so that individual departments, organizations, and individuals are notified that the data was provided by the first module, the third module performing specific tasks in an order in accordance with the business rules established by the second module.

36. The workstation of claim 35, wherein the second data module further comprises:
a first sub-module that analyzes the data and compiles trend information regarding the data.

37. The workstation of claim 36, wherein the second module executes a predetermined action if the trend information meets a trigger criterion.

38. The workstation of claim 37, wherein the predetermined action is to notify a designated user that the trend information met the trigger criteria.

39. The workstation of claim 37, wherein the predetermined action is to execute a change affecting at least one of the open architecture module, the autonomous agent module, the workflow module, the infrastructure connectivity module, the report engine module, the root cause analyzer module, or the data mining module.
